(19) United States
(12) Patent Application Publication
(10) Pub. No.: US 2002/0106453 A1
(43) Pub. Date: Aug. 8, 2002

(54) Static dissipative worksurfaces and method of fabrication

(76) Inventor: Dennis P. Miller, Columbus, OH (US)

Correspondence Address: MUELLER AND SMITH, LPA, MUELLER-SMITH BUILDING, 7700 RIVERS EDGE DRIVE, COLUMBUS, OH, 43235

(21) Appl. No.: 09/729,055

(22) Filed: Dec. 4, 2000

(51) Int. Cl. B05D 3/10

(52) U.S. Cl. 427/315; 427/316; 427/322

(57) ABSTRACT

The invention is a method for treating a worksurface of a workpiece to render it static dissipative under conditions of low relative humidity. Conditions are created that render the worksurface receptive to treatment with a electrostatic dissipative (ESD) agent. The receptive worksurface is contacted with an ESD agent. Finally, the conditions created to render the worksurface receptive are removed. One method for treating a worksurface of a workpiece to render it static dissipative under conditions of low relative humidity commences by contacting the worksurface with an aqueous bath comprising acid and poly(3,4-ethylene-dioxythiophene)-poly(styrenesulfonate). The worksurface is removed from the bath and excess bath is washed away from the worksurface. The worksurface finally is dried. The preferred acid is HCl. Another method involves heating the worksurface to render it receptive followed by treating with heated worksurface with the ESD agent and subjecting the treated worksurface to pressure.

### CROSS-REFERENCE TO RELATED APPLICATIONS

None

### STATEMENT REGARDING FEDERALLY SPONSORED RESEARCH

Not applicable.

### BACKGROUND OF THE INVENTION

The present invention relates generally to the fabrication of workbenches and more particularly to the fabrication of workbenches having static dissipative worksurfaces.

Static controlled worksurfaces are employed primarily in electronic manufacturing and repair environments to prevent over-voltage damage to electronic parts and assemblies. Other static sensitive environments using controlled worksurfaces include clean rooms (both medical and electronic) and combustible areas where munitions, electrically initiative explosive devices (EED's), and other hazardous or static sensitive items are processed and handled.

The focus of static dissipative worksurfaces used in electronic environments is to prevent electrostatic discharge (ESD) damage to electronic devices and related assemblies. In order to be a successful ESD worksurface, several concerns must be addressed, i.e., mechanical considerations, chemical considerations, electrical considerations, safety considerations, and value considerations.

Mechanical considerations include the physical requirements of the finished worksurface, which must possess acceptable mechanical characteristics, such as, color; light reflecting (glare) properties; ease of installation and maintenance (cleanability); cushioning or hardness characteristics; resistance to abrasion, chemicals, heat, etc.; and expected life. Chemical considerations include product or area contamination, which include contact transfer of chemicals from the worksurface to parts and assemblies; flammability of the worksurface; absence of chemicals that might contaminate the process or environments (e.g., nitrates, nitrites, chlorides, etc.); and particulation or sloughing of particles from the worksurface during normal use.

Electrical considerations include charge generated by the worksurface onto the devices making intimate contact with the product (see, ESD Association ESD STM 4.2-1998); worksurface charge outcome (see, ESD Association ESD STM 4.1-1997); worksurface charge dissipative characteristics (see, ESD Association ESD STM 4.2-1998); and surface resistance (see, Surface Resistance per ESD STM S11.11 and Volume (Bulk) Resistivity per ESD STM S11.112). Safety considerations include produce disposal or reuse at the end of its useful life and personnel safety. Value considerations include the ability of the worksurface to not only meet general assembly applications to be certifiable/compliant with applicable performance standards, but also clean room applications; and price.

Worksurfaces often are made from standard laminated products that are by nature insulators (e.g., Formica® brand laminates (e.g., Grade 12) from Formica Corporation and Wilsonart® laminates (e.g., Type 350) from Wilsonart International, Temple, Tex.). Thus, such laminates must be treated and/or modified in order to render them static dissipative. One such technique for treating such laminates is U.S. Pat. No. 4,988,419, which proposes to immerse the laminates in a bath containing silver nitrate crystals while passing alternating current through the bath. Despite this and other proposals, there exits a need in the art for worksurfaces that dissipate charge, especially under conditions of low humidity (i.e., below about 30% relative humidity or r.h.)

### BRIEF SUMMARY OF THE INVENTION

The present invention utilizes the unexpected discovery that through selected means, the thermoset top and bottom layers of high pressure paper laminates can be made receptive to permanent incorporation of functional particles and materials. These functional particles are permanently bound to (within) the surface of the melamine decorative layer of the laminates and cannot be removed by repeated washing and abrasion. This invention, therefore, attaches the functional materials to (within) the surface of the high-pressure laminate without using a separate binder resin or other binding system, such as is used in a coating. Thus, the invention avoids the problems inherent in coating cured melamine worksurfaces with the added benefit that the functional particles are not encapsulated or other bound within the binder of a coating. This means that the functional particles are free to function and to interact with (at) the topmost surface of the laminate and the immediate environment. This ability allows electrically conductive functional materials, bacterial disinfecting agents, and other active/functional materials to be placed permanently into the topmost layer of the high-pressure laminate without using an external binder system.

Normally, thermoset melamine and phenolic chemistries are tough and stable materials that are not reactive with other materials and are functionally set in their form and properties. The present invention describes the unexpected finding that at least two methods are available for activating the thermoset materials making them receptive to inclusion of selected functional/active materials. These activation methods under the proper conditions do not destroy the laminate's integrity nor its aesthetic qualities. After removal of the activating method, the laminate returns to its original character, i.e., it has regained its thermoset physical properties, with the functional material retained in the thermoset material

One method for accomplishing the foregoing is to use a water-soluble acid either in an immersion bath setup or as a component of a liquid surface treatment applied either by spray or other suitable means. A second method uses heat and pressure in conjunction with selected organic solvent(s) to activate the surface. In the bath immersion regimen, the laminate may be activated first followed by application of the functional material. Alternatively, activation and functional material may be applied simultaneously. The chemistry of the functional material to be implanted in the surface layer must be considered in developing an effective process by combining these requirements with the activation parameters of the laminate itself.

An accomplishment of the present invention is the ability to produce specific surface resistivity performance in the decorative surface layer of a high-pressure paper laminate. By creating the proper level of surface resistivity (or conductivity), the laminate becomes a protective electrostatic discharge protection surface when it is installed in a worksurface or other device that is properly grounded and part of an overall electrostatic discharge protection device. By selecting specific inherently conductive materials whose electrical conductivity characteristics are not influenced by ambient humidity. A functional surface is formed that can be used to produce a worksurface or other structure whose electrostatic discharge protection is not dependent upon ambient humidity. This type of worksurface is highly desirable and is a significant improvement over the existing laminate worksurface products designated for ESD protection and whose surface resistivity values increase at low humidity to unacceptable levels.

The invention advantageously, then, is a method for treating a worksurface of a workpiece to render it static dissipative under conditions of low relative humidity. Conditions are created that render the worksurface receptive to treatment with a electrostatic dissipative (ESD) agent. The receptive worksurface is contacted with an ESD agent. Finally, the conditions created to render the worksurface receptive are removed. One method for treating a worksurface of a workpiece to render it static dissipative under conditions of low relative humidity commences by contacting the worksurface with an aqueous bath comprising acid and poly(3,4-ethylene-dioxythiophene)-poly(styrenesulfonate). The worksurface is removed from the bath and excess bath is washed away from the worksurface. The worksurface finally is dried. The preferred acid is HCl. Another method involves heating the worksurface to render it receptive followed by treating with heated worksurface with the ESD agent and subjecting the treated worksurface to pressure. These techniques can be applied to any thermoset surface.

### DETAILED DESCRIPTION OF THE INVENTION

A variety of chemical agents have been proposed for treating worksurfaces to render them static dissipative. These agents all work to a degree. Even when they do impart static dissipative properties to the worksurface, such static dissipative properties often rapidly dissipate when the relative humidity is lowered. For present purposes “low humidity” conditions comprehend r.h. conditions of not substantially above about 30% r.h. Thus, an important characteristic of the inventive worksurface is its ability to substantially maintain its static dissipative properties under conditions of low humidity.

Target performance for a worksurface to be capable of dissipating charge is given in ESD STM 4.1-1997 as follows:

a. Resistance Point to Point (RTT) Minimum: 5.0×10⁶ ohms Maximum: 5.0 10⁷ ohms

b. Resistance Point to Groundable Point (RTG) Minimum: 2.0×10⁶ ohms Maximum: 5.0×10⁷ohms

The invention operates to render the worksurface receptive (or active) to treatment with an ESD agent. Whether such treatment physically softens the worksurface, opens up existing pores, or creates new pores is not presently known, and does not really matter as efficacy of the treatment is established by the data in the examples. Importantly, the surface of the worksurface appears to return to its original, unaltered thermoset state upon removal of the treatment and/or treatment conditions.

Referring initially to the aqueous bath treating embodiment, the aqueous treating bath of the present invention comprises a material whose conductance is not humidity dependent, such as, for example, poly(3,4-ethylene-dioxythiophene)-poly(styrenesulfonate) dispersed in water, indium tin oxide (ITO), Ag particles, or the like. Optionally, acid, water-soluble organic solvent, or the like can be added to enhance the ESD additive's power and affect.

The bath preferably contains poly(3,4-ethylene-dioxythiophene)-poly(styrenesulfonate) (PEDT/PSS) (Baytron P, CAS No. 1555090-83-8, Bayer Corporation, Pittsburgh, Pa.). Baytron P is a transparent, flexible conductive polymer that exists in many grades, including VP Al 4083 and CH 8000. These grades differ in PEDT and PSS content, which are 0.025%/1.5% and 0.14%/2.6%, respectively. Surprisingly, it has been determined that Baytron P, preferably along with acid, can be used to treat laminate worksurfaces to impart permanent static dissipative properties suitable for use in electronics assembly. The amount of Baytron P ranges from about 0.5% to 30% by weight of the bath with amounts greater than 1.5% currently preferred. The nominal particle size of Baytron P is around 75 nanometers. Thus, inventive treatment renders the surface of the workpiece receptive to the Baytron P or other conductive agent used.

Alternatively, the worksurface can be treated with 3,4-ethylenedioxythiophene (EDT, C₆H₆O₂S, CAS #126213-50-1, MW 142.17 g/mol, Baytrone® M, Bayer Corporation) and polymerized in situ with catalyst to form the conductive polymer, poly(3,4-ethylenedioxythiophene). One such suitable catalyst is iron (III) toluenesulfonate as a solution in butanol, Fe(CH₃C₆H₄SO₃)₃ (MW 569.53 g/mol, Baytron C, Bayer Corporation). The polymerization of EDT proceeds at room temperature.

Referring to the optional acid, the preferred acid is HCl (muriatic acid). The concentration of acid ranges from about 0.2% to 3% by weight of the bath. Other suitable acids include, for example, other mineral acids such as, for example, sulfuric acid; organic acids, such as, for example, acetic acid and para-toluene sulfonic acid; and the like and mixtures thereof. Care must be exercised that the acid content is controlled at the expense of laminate degradation (blistering).

Other optional ingredients for inclusion in the bath include, for example, water soluble/miscible solvents (e.g., dimethyl sulfoxide or DMSO, n-methyl pyrrolidone or NMP, or the like), wetting agents or surfactants, and the like. Additionally, agents that are directed to prevention/suppression of mildew (mildewcides), bacteria (bacteriastats), insects (insecticides), etc., can be incorporated into the treating agent.

In treating laminate, solid, or other workpieces having worksurfaces in a one-bath scheme, the worksurface advantageously is immersed in the treating bath. Any suitable technique for contacting the worksurface with the treating bath for times of around 30 minutes (broadly, from about 15 to 45 minutes) at ambient indoor temperature will be acceptable. Thereafter, the workpiece is removed from the bath and washing with water, optionally using a sponge, rag, or other scrubbing item) until the surface is non-silting. Thereafter, the surface is washed with water until it is clear. A rag may be used to wipe the surface during this ultimate washing operation. Finally, the worksurface may be dried and is ready for use.

Alternatively, a two-bath treating scheme can be used. In this treatment schema or mode, the workpiece having a worksurface is soaked in an aqueous HCl bath (say, around 2.64% HCl) at room temperature for 45 minutes. The workpiece is removed from the bath, excess bath permitted to run off, and then placed in a second distilled water bath for 15 minutes at room temperature. Again, the workpiece is removed from the bath, excess bath permitted to run off, and then placed in a vertical position for spraying with Baytron P (20 vol-% solution in dimethylsulfoxide, DMSO). After sitting vertical for 30 minutes, the workpiece is set in the sun or exposed to other drying conditions.

It should be mentioned that the use of low pressures (say, around 5-10 psi) and moderate heating (say, around 220° F.), e.g., steam pressure and temperature, for a short duration (say, around 5 minutes) can be used to prepare the workpiece for treating with Baytron P or other ESD agent.

As a further alternative treatment embodiment, the workpieces can be pre-heated (say, to around 200° F.) and then subjected to pressure at elevated temperature (say, around 300° F) with DMSO or other suitable solvent and Baytron P or other conductive agent to render the worksurface static dissipative. Acid is optional in this treatment scheme, but may be useful to enhance the permanent ESD characteristics of the treated workpiece. Pre-heating and pressure treatment both can be accomplished using heated pressure rollers. Pressure treatment for around a few seconds to a few minutes, depending upon line speed, at around 670 psi (at the nip) have been found adequate for present purposes. Higher and lower pressures (say, from 2000 to 2,000 psi) and temperatures (say, from 200° to 340° F.) can be used depending upon the composition of the workpiece, treating agent, presence of acid, line speed, and like factors. Obviously, the treating schemes described above illustrate the invention and are not a limitation of it.

Regardless of the treatment modality used, the workpieces are post-formable after treatment is post-formable workpieces were subject to the inventive treatment. In this regard, additional workpieces that can be treated in accordance with the present invention include plastic films, trays, etc., which materials can be used in packaging and handling operations where, for example, static dissipative properties are desired and/or required. Additional worksurfaces include, for example, any thermoset surface, including those manufactured from melamines, phenolics, acrylics, polyesters, and like thermoset polymeric surfaces (e.g., CORIAN® as described in U.S. Pat. No. 3,847,865).

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by volume, unless otherwise expressly indicated. Also, all citations referred herein are expressly incorporated herein by reference.

### EXAMPLES

### Example 1

A treatment bath was compounded from the following ingredients:

TABLE 1
Sample 55/49-2

| Ingredient | Amount (ml) |
|---|---|
| HCl (20% conc. muriatic acid) | 57 |
| Baytron P* | 285 |
| Distilled Water | 5358 |

*Baytron P is poly(3,4-ethylene-dioxythiophene)-poly(styrenesulfonate), CAS No. 1555090-83-8, Bayer Corporation

A series of large laminate samples (12″×22″) were subjected to treatment with the treatment bath for 30 minutes at 72° C. After treatment, each sample was washed with the treatment bath using a synthetic sponge until a non-silted surface developed. The samples then were air dried. When both the front and back surfaces were dry, the front surface was washed with distilled water until a cleaning towel remained clear.

Resistance readings were taken with an Ohm-Stat® RT-1000 Megohmmeter (Static Solutions, Inc., Marlborough, Mass.). All readings were taken in accordance with the manufacturer's recommendations for use of the machine using either the parallel resistivity method or the point-to-point method.

The laminate samples were various colored WilonArt® brand horizontal laminates (Postforming type 350, sheet thickness of 0.039″±0.005″) that comply with the American National Standards Institute/National Electrical Manufacturers Association (ANSI/NEMA) standard LD3-1995 for high-pressure laminate. The following electrical conductivity data was recorded:

TABLE 2

| Sample | | | | % Relative | Temperature |
|---|---|---|---|---|---|
| No. | Laminate Color | ¹Resistivity (Ω) | | Humidity | (° F.) |
| 74-1 | Granite Green | 1.43 | E7 | 42.3 | 79.1 |
| 74-1 | Granite Green | 7.53 | E8 | 19.0 | 68.9 |
| 74-2 | Gray | 6.11 | D6 | 54.0 | 70.0 |
| 74-2 | Gray | 4.70 | E7 | 25.8 | 69.8 |
| 74-3 | Dark Green | 5.1 | E7 | 54.0 | 67.3 |
| 74-4² | Wood Grain | 1.0 | E8 | 54.0 | 70.0 |
| 74-4² | Wood Grain | 9.8 | E8 | 25.0 | 70.0 |
| 75-5 | Gray | 9.12 | E6 | 54.0 | 70.0 |
| 75-5³ | Gray | 4.5 | E7 | 54.0 | 70.0 |
| 75-5 | Gray | 1.61 | E8 | 25.2 | 69.8 |

¹Parallel Resistivity Method; by convention E7 is 10⁻⁷, E6 is 10⁻⁶, etc.
²Average of 4 readings.
³Sample re-checked the next day.

The above-tabulated results indicate that the novel treatment method resulted in maintaining the surface resistivity (conductivity) of the treated laminates even at reduced humidity. Note, that color of the laminate was not a limitation on the inventive treatment.

### Example 2

A two-bath procedure was followed wherein laminate 103-8 (Wilsonart gray laminate) was soaked in a 2.64 vol-% HCl bath for 45 minutes followed by spraying with a 20 vol-% Baytron P/80 vol-% DMSO solution for 1-2 minutes and air drying. Laminate 106-8 (Wilsonart gray laminate) was soaked in the same acid bath for 35 minutes after which it was soaked in a water bath for 15 minutes. A 10 vol-% Baytron P/90 vol-% DMSO) spray was applied to this laminate followed by a 40 minute vertical air dry and then placement in the sun. A third, comparative sample (laminate 92-5, (Wilsonart gray laminate) was not soaked in the acid bath first, but only had its rear side sprayed with a 20 vol-% Baytron P/80 vol-% DMSO solution. A fourth, comparative sample (laminate 92-6) was not soaked in any bath, but had both sides (front and back) sprayed with acid only. The following data was recorded.

TABLE 3

| | Lami- | | | % | Temper- |
|---|---|---|---|---|---|
| | nate | Resistivity² | | Relative | ature |
| Sample No.¹ | Color | (Ω) | | Humidity | (° F.) |
| 103-8 | Gray | 7.3 | E6 | 23.2 | 66.4 |
| 103-8 | Gray | 6.6 | E6 | 50.8 | 67.8 |
| 106-8 (front) | Gray | 0.5 | E7 | 16.3 | 63.4 |
| 106-8 (front) | Gray | 0.1 | E7 | 40.1 | 70.2 |
| 106-8 (back) | Gray | 6.8 | E8 | 12.9 | 64.9 |
| 106-8 (volume) | Gray | 7.8 | E6 | 13.1 | 53.3 |
| 92-5 (front) | Gray | 4.1 | E10 | 20.5 | 60.0 |
| 92-5 (front) | Gray | 7.1 | E9 | 44.1 | 70.2 |
| 92-5 (back) | Gray | 8.1 | E5 | 20.6 | 61.1 |
| 92-5 (back) | Gray | 2.8 | E6 | 44.5 | 70.1 |
| 92-5 (volume) | Gray | 1.2 | E9 | 44.5 | 70.1 |
| 92-6 (front) | Gray | 2.3 | E10 | 44.1 | 70.3 |
| 92-6 (front) | Gray | 8.5 | E10 | 20.5 | 60.0 |
| 92-6 (back) | Gray | 4.6 | E9 | 44.1 | 70.2 |
| 92-6 (back) | Gray | 6.1 | E10 | 20.6 | 61.1 |
| 92-6 (volume) | Gray | 1.2 | E9 | 44.3 | 70.3 |
| 92-5 (control, front) | Gray | 1.5 | E10 | 44.4 | 70.1 |
| 92-5 (control, back) | Gray | 6.3 | E9 | 44.4 | 70.3 |
| 92-5 (control, volume) | Gray | 6.8 | E8 | 44.5 | 70.2 |

¹Measurement readings taken on front, back, or through (volume) of laminate.
²Point-to-point test method

This data again establishes that the novel treatment regimen is effective in imparting static dissipative functionality to the treated workpieces. Such functionality also is substantially maintained under low r.h. conditions.

### Example 3

A heated pressure procedure involved running the laminates through the pressure nip of a roller press assembly to pre-heat the laminates to around 200° F. The worksurfaces then were treated with Baytron P and DMSO and run through the roller press again to heat the workpieces to around 300° F. Static dissipative measurements were taken following cooling of the workpieces. The following results were recorded.

TABLE 4

| | | Roller | Line | | | | | | Performance | | | | |
|---|---|---|---|---|---|---|---|---|---|---|---|---|---|
| Run | | Temp | Speed | Pre- | Treating | Ctg Wt | Press | Size | | | | Temp | |
| No. | Color³ | (° F.) | (ft/min) | Heat | Agent¹ | (g/ft²) | (psi) | (in) | Ω | | R.H. | (° F.) | Comments |
| 117-1 | Gray | 400 | 2 | N | 35% BayP | +3 | 888.9 | 9 ⅛ × | 1.1 | E5 | 36.4 | 68.3 | Double sprayed |
| | Speckle | | | | 65% DMSO | | | 14 ¼ | 2.1 | E5 | 17.1 | 50.1 | with BayP/DMSO; |
| | | | | | | | | | 1.6 | E5 | 40.9 | | double pressed; |
| | | | | | | | | | | | | | washed twice |
| 117-2 | Gray | 400 | 4 | N | 35% BayP | 3.1 | 666.6 | 12 × 12 | 4.8 | E6 | 36.5 | ˜65 | Single spray; |
| | Speckle | | | | 65% DMSO | | | | 1.6 | E5 | 18.0 | 61.5 | some |
| | | | | | | | | | 1.8 | E5 | 40.8 | 62.0 | inconsistency due |
| | | | | | | | | | | | | | to coating problem |
| 117-3 | Gray | 240 | 2 | N | 35% BayP | ˜3 | 666.6 | 12 × 12 | 2 | E8 | 36.8 | 68.6 | Liquid dried |
| | Speckle | | | | 65% DMSO | | | | 1.7 | E8 | 16.9 | 51.0 | outside of nip in |
| | | | | | | | | | 1.9 | E8 | 40.7 | 61.8 | about 10 seconds |
| 117-4 | Gray | 400 | 2 | Y | 35% BayP | 3.1 | 666.6 | 12 × 12 | | E5 | — | — | No change after |
| | Speckle | | | | 65% DMSO | | | | 1.6 | E5 | 18.0 | 51.5 | washing for initial |
| | | | | | | | | | 1.8 | E5 | 40.8 | 62.0 | readings |
| 117-5 | Gray | 400 | 2 | N | 35% BayP | 2.3 | 666.6 | 12 × 12 | 8.3 | E8 | 36 | 68.6 | Initial reading is |
| | Speckle | | | | 65% DMSO | | | | 3.0 | E9 | 40.9 | 59.3 | after first wash |
| 118-1 | Gray | 400 | 2 | N | 25% BayP | Light | 592.0 | 13.5 × 17 | 4.3 | E8 | 36.5 | 68.4 | Some variation |
| | Speckle | | | | 75% DMSO | spray | | | 2.7 | E9 | 40.5 | 60.7 | over sheet in |
| | | | | | | | | | | | | | direction of |
| | | | | | | | | | | | | | nip - varies to 6.4 |
| | | | | | | | | | | | | | E8 at one end |
| 118-2 | Gray | 400 | 2 | Y | 100% BayP | Brush | 571 | 15 × 14 | 9.6 | E5 | 36.6 | 68.6 | Used 2 heated |
| | Speckle | | | | | Heavy | | | 9.7 | E5 | 40.4 | 61.1 | passes in |
| | | | | | | | | | | | | | saturated areas |
| 118-3 | Gray | 400 | 2 | Y | 100% BayP | Brush | 571 | 15 × 14 | 9.0 | E6 | 37.1 | 68.6 | One pass through |
| | Speckle | | | | | Heavy | | | 1.3 | E7 | 40.7 | 61.4 | nip; lots of |
| | | | | | | | | | | | | | variability in stain |
| | | | | | | | | | | | | | level |
| 118-4 | Gray | 400 | 2 | Y1 | 100% BayP | Brush | 695.6 | 1.5 × 18 | 3.0 | E9 | 36.4 | 68.5 | Pressed with |
| | Speckle | | | | | Heavy | | | 2.7 | E9 | 40.8 | 61.4 | back-coated side |
| | | | | | | | | | | | | | up; front side dirty |
| | | | | | | | | | | | | | from rubber; |
| | | | | | | | | | | | | | measured front |
| 118-5 | Gray | 400 | 2 | Y | 20% BayP | Brush | 666.6 | 12 × 18 | 3.6 | E7² | 32.2 | 62.8 | Back side coated, |
| | Speckle | | | | 80% DMSO | Heavy | | | 3.5 | E9 | 32.3 | 62.6 | pressed with |
| | | | | | (Back side) | | | | 2.5 | E9 | 41.0 | 61.4 | back side up to |
| | | | | | | | | | | | | | heated upper |
| | | | | | | | | | | | | | roller |
| 119-1 | Gray | 400 | 2 | N | 20% BayP | Brush | 800 | 10 × 15 | 1.3 | E8 | 32.6 | 63.3 | Allowed to dry 20 |
| | Speckle | | | | 80% DMSO | Heavy | | | 4.1 | E9 | 40.8 | 62.0 | min at RT before |
| | | | | | | | | | | | | | pressing; poor |
| | | | | | | | | | | | | | appearance |
| 119-2 | Gray | 400 | 2 | N | 20% BayP | Brush | 727.3 | 11 × 14 | 1.7 | E10 | 32.4 | 63.1 | Front side |
| | Speckle | | | | ˜5% | Heavy | | | | | | | coating, variable |
| | | | | | AA/Water³ | | | | | | | | results; poor |
| | | | | | | | | | | | | | appearance |
| 119-3 | Gray | 400 | 2 | Y | 20% BayP | Brush | 1000 | 8 × 14 | 1.4 | E10 | 31.7 | 63.4 | Back side coating, |
| | Speckle | | | | ˜5% AA³ | Rear | | | | | | | pressed coated |
| | | | | | Bal. Water | Heavy | | | | | | | side up; poor |
| | | | | | | | | | | | | | appearance |
| 119-4 | Beige | 400 | 2 | N | 20% BayP | Brush | 1600 | 5 × 24 | 3.5 | E9 | 36.5 | 68.2 | Bad staining to |
| | | | | | 80% H₂O | Heavy | | | 6.1 | E9 | 40.4 | 62.0 | moderate staining |

¹BayP is Baytron P.
²AA is high molecular weight (250,000 MW) acrylic acid.
³Wilsonart laminates.

The above-tabulated results demonstrate that heat and pressure can be used instead of acid to render the laminate surface receptive to the electrostatic discharge additive. ESD activity is seen with Baytron P only, i.e., without use of acid or DMSO. Again, color of the laminate is not seen to influence the inventive ESD treatment. The use of DMSO does greatly improve efficiency of take-up of the Baytron P and develops much improved aesthetics of the treated workpiece.

1. A method for treating a worksurface of a workpiece for incorporation of an active additive thereinto, which comprises the steps of:
(a) creating conditions that render said worksurface receptive to treatment with said additive;
(b) contacting said receptive worksurface with additive;
(c) removing said conditions created in step (a).

2. The method of claim 1, wherein said active additive is one or more of an electrostatic dissipative (ESD) agent, a bacteriastat, a mildewcide, or an insecticide.

3. The method of claim 1, wherein said conditions created in step (a) include contacting said worksurface with an aqueous bath comprising acid and poly(3,4-ethylene-dioxythiophene)-poly(styrenesulfonate).

4. The method of claim 3, wherein step (a) is conducted by the steps of:
(a1) contacting said worksurface with an acid bath, and
(a2) contacting said worksurface from step (a1) with an aqueous bath of poly(3,4-ethylene-dioxythiophene)-poly(styrenesulfonate).

5. The method of claim 3, wherein said acid bath comprises acid in dimethyl sulfoxide (DMSO).

6. The method of claim 1, wherein said conditions created in step (a) include the heating of said worksurface to a temperature of between about 200° and 340° F.

7. A method for treating a worksurface of a workpiece to render it static dissipative under conditions of low relative humidity, which comprises the steps of:
(a) contacting said worksurface with a solution containing an electrostatic dissipative (ESD) agent;
(b) removing said worksurface from said solution and washing away any excess solution from said worksurface; and
(c) drying said worksurface.

8. The method of claim 7, wherein said ESD agent is one or more of poly(3,4-ethylene-dioxythiophene)-poly(styrenesulfonate), indium tin oxide, and silver particles.

9. The method of claim 7, wherein said workpiece is contacted in step (a) with an aqueous bath comprising acid and poly(3,4-ethylene-dioxythiophene)-poly(styrenesulfonate).

10. The method of claim 9, wherein said bath contains between about 0.5% and 30% by weight of said poly(3,4-ethylene-dioxythiophene)-poly(styrenesulfonate).

11. The method of claim 9, wherein said acid is a mineral acid or an organic acid.

12. The method of claim 11, wherein said acid comprises HCl.

13. The method of claim 12, wherein said aqueous bath also contains a water-soluble organic solvent.

14. The method of claim 13, wherein said organic solvent is DMSO.

15. The method of claim 7, wherein said workpiece is subjected to one or more of heating or heating and pressure prior to step (a).

16. The method of claim 15, wherein said workpiece is subjected to heating, contacted with said ESD agent, and then subjected to heating and pressure.

17. The method of claim 16, wherein said workpiece is first heated to about 200° F., contacted with poly(3,4-ethylene-dioxythiophene)-poly(styrenesulfonate), and then subjected to heating between about 200° and 340° F. and pressure of between about 200 and 2000 psi.

18. The method of claim 17, wherein said heated workpiece is contacted with an aqueous solution of water soluble organic solvent and poly(3,4-ethylene-dioxythiophene)-poly(styrenesulfonate).

19. The method of claim 18, wherein said water-soluble organic solvent is DMSO.

20. The method of claim 18, wherein said aqueous solution also contains an acid.

21. The method of claim 20, wherein said acid is HCl.

22. The method of claim 18, wherein said aqueous solution contains between about 0.5% and 30% by weight of said poly(3,4-ethylene-dioxythiophene)-poly(styrenesulfonate).

23. The method of claim 22, wherein said workpiece is dried and thermally post-formed.

24. The method of claim 7, wherein said workpiece is contacted with 3,4-ethylenedioxythiophene and iron (III) toluenesulfonate catalyst to in situ form poly(3,4-ethylene-dioxythiophene).
